(19) United States
(12) Patent Application Publication
(10) Pub. No.: US 2025/0338321 A1
(43) Pub. Date: Oct. 30, 2025

(54) TECHNIQUES ASSOCIATED WITH CONTENTION WINDOW SIZE SELECTION IN WI-FI SYSTEMS

(71) Applicant: QUALCOMM Incorporated, San Diego, CA (US)

(72) Inventors: Srinivas KATAR, Fremont, CA (US); Maarten Menzo WENTINK, Nijmegen (NL); George CHERIAN, San Diego, CA (US); Jinsung LEE, San Jose, CA (US); Naveen Kumar KAKANI, Flower Mound, TX (US); Raja BANERJEA, Saratoga, CA (US); Alfred ASTERJADHI, San Diego, CA (US); Xiaolong HUANG, Santee, CA (US)

(21) Appl. No.: 19/186,407

(22) Filed: Apr. 22, 2025

Related U.S. Application Data
(60) Provisional application No. 63/638,122, filed on Apr. 24, 2024.

(51) Int. Cl. H04W 74/0833; H04L 5/00; H04W 28/06

(52) U.S. Cl. CPC H04W 74/085; H04L 5/0053; H04W 28/06

(57) ABSTRACT

This disclosure provides methods, components, devices and systems for techniques associated with contention window size selection in Wi-Fi systems. Some implementations relate to mechanisms according to which a wireless communication device may select a contention window size for a transmission attempt to maintain relatively smaller contention window sizes in some scenarios and to use relatively larger contention window sizes in some other scenarios. In some examples, a wireless communication device may statically use a same contention window size for a given access category. Additionally, or alternatively, the wireless communication device may use a first contention window size for a first quantity of transmission attempts and a second contention window size for a second quantity of transmission attempts. Additionally, or alternatively, the wireless communication device may use a selection scheme according to which the wireless communication device directly maps a collision probability to a contention window size.

### CROSS REFERENCE

The present Application for Patent claims benefit of U.S. Provisional Patent Application No. 63/638,122 by KATAR et al., entitled “TECHNIQUES ASSOCIATED WITH CONTENTION WINDOW SIZE SELECTION IN WI-FI SYSTEMS,” filed Apr. 24, 2024, assigned to the assignee hereof, and expressly incorporated herein.

### TECHNICAL FIELD

This disclosure relates generally to wireless communication and, more specifically, to techniques associated with contention window size selection in Wi-Fi systems.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a wireless station (STA) (or any other wireless communication device). The method may include activating an application associated with a traffic flow that corresponds to an access category, performing a first set of two or more consecutive transmission attempts of a packet associated with the traffic flow in association with selecting backoff values from a first contention window size associated with the access category, and performing a second set of one or more consecutive transmission attempts of the packet in association with selecting one or more backoff values from a second contention window size associated with the access category in accordance with a failure of the first set of two or more consecutive transmission attempts of the packet.

Another innovative aspect of the subject matter described in this disclosure can be implemented in a wireless STA (or any other wireless communication device) for wireless communication. The wireless STA may include a processing system that includes processor circuitry and memory circuitry that stores code. The processing system may be configured to cause the wireless STA to activate an application associated with a traffic flow that corresponds to an access category, perform a first set of two or more consecutive transmission attempts of a packet associated with the traffic flow in association with selecting backoff values from a first contention window size associated with the access category, and perform a second set of one or more consecutive transmission attempts of the packet in association with selecting one or more backoff values from a second contention window size associated with the access category in accordance with a failure of the first set of two or more consecutive transmission attempts of the packet.

Another innovative aspect of the subject matter described in this disclosure can be implemented in a wireless STA (or any other wireless communication device) for wireless communication. The wireless STA may include means for activating an application associated with a traffic flow that corresponds to an access category, means for performing a first set of two or more consecutive transmission attempts of a packet associated with the traffic flow in association with selecting backoff values from a first contention window size associated with the access category, and means for performing a second set of one or more consecutive transmission attempts of the packet in association with selecting one or more backoff values from a second contention window size associated with the access category in accordance with a failure of the first set of two or more consecutive transmission attempts of the packet.

Another innovative aspect of the subject matter described in this disclosure can be implemented in a non-transitory computer-readable medium storing code for wireless communication by a wireless STA (or any other wireless communication device). The code may include instructions executable by one or more processors to activate an application associated with a traffic flow that corresponds to an access category, perform a first set of two or more consecutive transmission attempts of a packet associated with the traffic flow in association with selecting backoff values from a first contention window size associated with the access category, and perform a second set of one or more consecutive transmission attempts of the packet in association with selecting one or more backoff values from a second contention window size associated with the access category in accordance with a failure of the first set of two or more consecutive transmission attempts of the packet.

Some examples of the method, wireless STAs, and non-transitory computer-readable medium described herein may further include operations, features, means, or instructions for receiving an indication of a first quantity of the first set of two or more consecutive transmission attempts, where the first quantity may be associated with the access category.

Some examples of the method, wireless STAs, and non-transitory computer-readable medium described herein may further include operations, features, means, or instructions for determining, within a first time period, a first collision probability associated with transmission attempts from the wireless STA and determining a first quantity of the first set of two or more consecutive transmission attempts in accordance with the first collision probability, where performing the first set of two or more consecutive transmission attempts may be in association with determining the first quantity of the first set of two or more consecutive transmission attempts.

Some examples of the method, wireless STAs, and non-transitory computer-readable medium described herein may further include operations, features, means, or instructions for determining, within a second time period, a second collision probability associated with the transmission attempts from the wireless STA and updating the first quantity to a second quantity in accordance with the second collision probability.

In some examples of the method, wireless STAs, and non-transitory computer-readable medium described herein, a mapping associated with the access category indicates a correspondence between a set of collision probabilities and a set of quantities of consecutive transmission attempts using the first contention window size.

In some examples of the method, wireless STAs, and non-transitory computer-readable medium described herein, in accordance with the mapping, a relatively smallest quantity of consecutive transmission attempts using the first contention window size corresponds to a relatively highest collision probability of the set of collision probabilities and a relatively largest quantity of consecutive transmission attempts using the first contention window size corresponds to a relatively lowest collision probability of the set of collision probabilities.

Some examples of the method, wireless STAs, and non-transitory computer-readable medium described herein may further include operations, features, means, or instructions for receiving an indication of the mapping.

In some examples of the method, wireless STAs, and non-transitory computer-readable medium described herein, the second set of one or more consecutive transmission attempts includes repeated transmission attempts using the second contention window size until a reception of an acknowledgment associated with the packet or until the packet may be dropped or discarded.

In some examples of the method, wireless STAs, and non-transitory computer-readable medium described herein, the first set of two or more consecutive transmission attempts includes a first quantity of consecutive transmission attempts and the second set of one or more consecutive transmission attempts includes a second quantity of consecutive transmission attempts and the access category may be associated with a repeating pattern of the first quantity of consecutive transmission attempts using the first contention window size followed by the second quantity of consecutive transmission attempts using the second contention window size.

In some examples of the method, wireless STAs, and non-transitory computer-readable medium described herein, the first set of two or more consecutive transmission attempts and the second set of one or more consecutive transmission attempts may be associated with a sequence of consecutive transmission attempts of the packet according to which a contention window size may be not doubled in accordance with an initial transmission attempt of the packet failing.

In some examples of the method, wireless STAs, and non-transitory computer-readable medium described herein, the first contention window size may be smaller than the second contention window size.

In some examples of the method, wireless STAs, and non-transitory computer-readable medium described herein, the access category may be associated a baseline set of contention window sizes and the first contention window size may be smaller than a smallest contention window size of the baseline set of contention window sizes.

Another innovative aspect of the subject matter described in this disclosure can be implemented in a method for wireless communication by a wireless STA (or any other wireless communication device). The method may include activating an application associated with a traffic flow that corresponds to an access category and performing a transmission attempt of a packet associated with the traffic flow in association with selecting a backoff value from a first contention window size, where the first contention window size is associated with both the access category and a first collision probability associated with transmission attempts from the wireless STA.

Another innovative aspect of the subject matter described in this disclosure can be implemented in a wireless STA (or any other wireless communication device) for wireless communication. The wireless STA may include a processing system that includes processor circuitry and memory circuitry that stores code. The processing system may be configured to cause the wireless STA to activate an application associated with a traffic flow that corresponds to an access category and perform a transmission attempt of a packet associated with the traffic flow in association with selecting a backoff value from a first contention window size, where the first contention window size is associated with both the access category and a first collision probability associated with transmission attempts from the wireless STA.

Another innovative aspect of the subject matter described in this disclosure can be implemented in a wireless STA (or any other wireless communication device) for wireless communication. The wireless STA may include means for activating an application associated with a traffic flow that corresponds to an access category and means for performing a transmission attempt of a packet associated with the traffic flow in association with selecting a backoff value from a first contention window size, where the first contention window size is associated with both the access category and a first collision probability associated with transmission attempts from the wireless STA.

Another innovative aspect of the subject matter described in this disclosure can be implemented in a non-transitory computer-readable medium storing code for wireless communication by a wireless STA (or any other wireless communication device). The code may include instructions executable by one or more processors to activate an application associated with a traffic flow that corresponds to an access category and perform a transmission attempt of a packet associated with the traffic flow in association with selecting a backoff value from a first contention window size, where the first contention window size is associated with both the access category and a first collision probability associated with transmission attempts from the wireless STA.

Some examples of the method, wireless STAs, and non-transitory computer-readable medium described herein may further include operations, features, means, or instructions for determining, within a first time period, the first collision probability associated with the transmission attempts from the wireless STA and determining the first contention window size in accordance with the first collision probability, where performing the transmission attempt in association with selecting the backoff value from the first contention window size may be based on determining the first contention window size in accordance with the first collision probability.

Some examples of the method, wireless STAs, and non-transitory computer-readable medium described herein may further include operations, features, means, or instructions for determining, within a second time period, a second collision probability associated with the transmission attempts from the wireless STA, determining a second contention window size in accordance with the second collision probability, and performing a second transmission attempt of the packet or a second packet associated with the traffic flow in association with selecting a second backoff value from the second contention window size in accordance with determining the second contention window size in accordance with the second collision probability.

In some examples of the method, wireless STAs, and non-transitory computer-readable medium described herein, a mapping associated with the access category indicates a correspondence between a set of collision probabilities and a set of contention window sizes.

In some examples of the method, wireless STAs, and non-transitory computer-readable medium described herein, the set of contention window sizes may be associated with a lower limit contention window size and an upper limit contention window size.

In some examples of the method, wireless STAs, and non-transitory computer-readable medium described herein, in accordance with the mapping, a relatively largest contention window size of the set of contention window sizes corresponds to a relatively highest collision probability of the set of collision probabilities and a relatively smallest contention window size of the set of contention window sizes corresponds to a relatively lowest collision probability of the set of collision probabilities.

Some examples of the method, wireless STAs, and non-transitory computer-readable medium described herein may further include operations, features, means, or instructions for receiving an indication of the mapping.

Another innovative aspect of the subject matter described in this disclosure can be implemented in a method for wireless communication by a wireless STA (or any other wireless communication device). The method may include activating an application associated with a traffic flow that corresponds to an access category and performing a set of two or more consecutive transmission attempts of a packet associated with the traffic flow in association with selecting backoff values from a contention window size associated with the access category in accordance with a collision probability associated with transmission attempts from the wireless STA satisfying a threshold probability.

Another innovative aspect of the subject matter described in this disclosure can be implemented in a wireless STA (or any other wireless communication device) for wireless communication. The wireless STA may include a processing system that includes processor circuitry and memory circuitry that stores code. The processing system may be configured to cause the wireless STA to activate an application associated with a traffic flow that corresponds to an access category and perform a set of two or more consecutive transmission attempts of a packet associated with the traffic flow in association with selecting backoff values from a contention window size associated with the access category in accordance with a collision probability associated with transmission attempts from the wireless STA satisfying a threshold probability.

Another innovative aspect of the subject matter described in this disclosure can be implemented in a wireless STA (or any other wireless communication device) for wireless communication. The wireless STA may include means for activating an application associated with a traffic flow that corresponds to an access category and means for performing a set of two or more consecutive transmission attempts of a packet associated with the traffic flow in association with selecting backoff values from a contention window size associated with the access category in accordance with a collision probability associated with transmission attempts from the wireless STA satisfying a threshold probability.

Another innovative aspect of the subject matter described in this disclosure can be implemented in a non-transitory computer-readable medium storing code for wireless communication by a wireless STA (or any other wireless communication device). The code may include instructions executable by one or more processors to activate an application associated with a traffic flow that corresponds to an access category and perform a set of two or more consecutive transmission attempts of a packet associated with the traffic flow in association with selecting backoff values from a contention window size associated with the access category in accordance with a collision probability associated with transmission attempts from the wireless STA satisfying a threshold probability.

In some examples of the method, wireless STAs, and non-transitory computer-readable medium described herein, the collision probability satisfying the threshold probability includes the collision probability being less than the threshold probability.

In some examples of the method, wireless STAs, and non-transitory computer-readable medium described herein, the collision probability satisfying the threshold probability indicates a presence of fewer than a threshold quantity of traffic flows associated with the access category in a vicinity of the wireless STA.

In some examples of the method, wireless STAs, and non-transitory computer-readable medium described herein, the contention window size may be equal to three.

In some examples of the method, wireless STAs, and non-transitory computer-readable medium described herein, the contention window size may be equal to two.

In some examples of the method, wireless STAs, and non-transitory computer-readable medium described herein, the contention window size may be equal to one.

In some examples of the method, wireless STAs, and non-transitory computer-readable medium described herein, the set of two or more consecutive transmission attempts includes repeated transmission attempts using the contention window size until a reception of an acknowledgment associated with the packet or until the packet may be dropped or discarded.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIGS. 2A and 2B show example signaling diagrams that support techniques associated with contention window size selection in Wi-Fi systems.

FIG. 3 shows a block diagram of an example wireless communication device that supports techniques associated with contention window size selection in Wi-Fi systems.

FIGS. 4 through 6 show flowcharts illustrating example processes performable by or at a wireless station (STA) that supports techniques associated with contention window size selection in Wi-Fi systems.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, a wireless communication device may support one or more of various traffic flows associated with potentially different priorities. For example, the wireless communication device may support a first traffic flow associated with a first priority and a second traffic flow associated with a second priority. In some implementations, a wireless communication device (in accordance with a network specification) may use different access categories to send traffic of different priorities. For example, the first traffic flow may be associated with a first access category and the second traffic flow may be associated with a second access category. Some example access categories that a wireless communication device may support include background traffic, best effort traffic, video traffic, and voice traffic. Different access categories may be associated with different access parameters, such as different arbitration inter-frame spacing numbers (AIFSNs), different lower limit contention window sizes, or different upper limit contention window sizes. For example, for an uplink communication direction, a voice access category (AC_VO) may be associated with an AIFSN of two, a lower limit contention window size of three, and an upper limit contention window size of seven. In some networks, the voice access category may be associated with a relatively highest priority by way of being associated with relatively most favorable access parameters (such as parameters most likely to facilitate low-latency channel access).

In some scenarios, traffic associated with some access categories (such as the voice access category) may suffer from a high tail latency in the presence of other traffic. For example, uplink voice traffic may have a significant tail in an access delay cumulative distribution function (CDF) in the presence of downlink voice traffic and best effort traffic. Such a high (such as long) tail latency may be understood as or relate to how an access delay may increase (such as exponentially increase) with higher CDF values. Further, such a high tail latency may be due to packets of a relatively higher priority access category (such as the voice access category) having to wait for packet transmissions of a relatively lower priority access category, which may occur increasingly more often as a contention window size of the relatively higher priority access category increases (and becomes relatively more overlapping with a contention window size of the relatively lower priority access category). For example, voice packets may sometimes have to wait for best effort transmissions (which may be relatively longer in time, such as relatively larger packets).

Further, in some networks, a wireless communication device may increase (such as double or approximately double) a contention window size each time an attempted packet transmission fails, which may further drive the latency tail by potentially quickly increasing an overlap of contention window sizes of different access categories. Thus, for a given access category (such as for the voice access category), some networks may benefit from generally lower contention window size values to avoid backoff values that leak into a territory of back off values of other access categories (such as the best effort access category) while also avoiding too small backoff values in scenarios in which there are many (such as greater than a threshold amount of) traffic flows associated with that access category.

Various implementations relate generally to one or more signaling-based or configuration-based mechanisms according to which a wireless communication device may select a contention window size for a transmission attempt to maintain relatively smaller contention window sizes in some scenarios (such as in accordance with a satisfaction of a first set of one or more conditions) and to use relatively larger contention window sizes in some other scenarios (such as in accordance with a satisfaction of a second set of one or more conditions). Some example scenarios/conditions may include or relate to a congestion level, a quantity of previous transmission attempts, a collision probability, signaled/indicated activation or capability, signaled/indicated information, or any combination thereof. In some implementations, for example, a wireless communication device may statically (such as always or for a time duration) use a same contention window size for a given access category (such as for the voice access category). In such implementations, the wireless communication device may use the same contention window size for the access category in accordance with a presence of relatively few traffic flows associated with that access category (such as in accordance with relatively lower network congestion or a relatively low collision probability).

Additionally, or alternatively, a wireless communication device may use, employ, or leverage a contention window size selection scheme that (dynamically or in accordance with signaled information) scales with higher quantities of traffic flows associated with a given access category. In some implementations, for example, the wireless communication device may use a first contention window size for a first quantity of (consecutive) transmission attempts and may use a second contention window size for a second (subsequent) quantity of (consecutive) transmission attempts. In some implementations, the first contention window size may be smaller than the second contention window size. Further, in some implementations, the wireless communication device may receive an indication of one or both of the first quantity or the second quantity. In some other aspects, the wireless communication device may select one or more both of the first quantity or the second quantity. For example, the wireless communication device may select one or both of the first quantity or the second quantity in accordance with a collision probability. Additionally, or alternatively, the wireless communication device may use, employ, or leverage a contention window size selection scheme according to which the wireless communication device may directly map a collision probability to a fixed contention window size. For example, the wireless communication device may use a first contention window size in accordance with determining (such as measuring, calculating, estimating, or receiving information indicative of) a first collision probability and may use a second contention window size in accordance with determining a second collision probability.

Particular aspects of the subject matter described in this disclosure can be implemented to realize one or more of the following potential advantages. In some examples, by maintaining relatively smaller contention window sizes in some scenarios and using relatively larger contention window sizes in some other scenarios, the described techniques can be used to balance a likelihood for low-latency channel access with a likelihood for collisions while also trimming or reducing a latency tail associated with some access categories. For example, in accordance with using relatively smaller contention window sizes for relatively longer, or in select scenarios, a wireless communication device may achieve lower latency across various deployment situations and channel conditions (such as across various and diverse situations of differing amounts of traffic and of differing traffic access categories). Further, the described techniques may be associated with relatively minimal, if any, impact to devices of relatively lower capability, such that the described techniques may support backwards compatibility in various networks. Further, by way of reducing latency, the described techniques may be implemented to realize fewer packet drops/discards, fewer transmissions (in accordance with a relatively greater likelihood for successful communication), greater spectral efficiency, greater system capacity, higher data rates, greater power savings, and longer battery life, among other benefits.

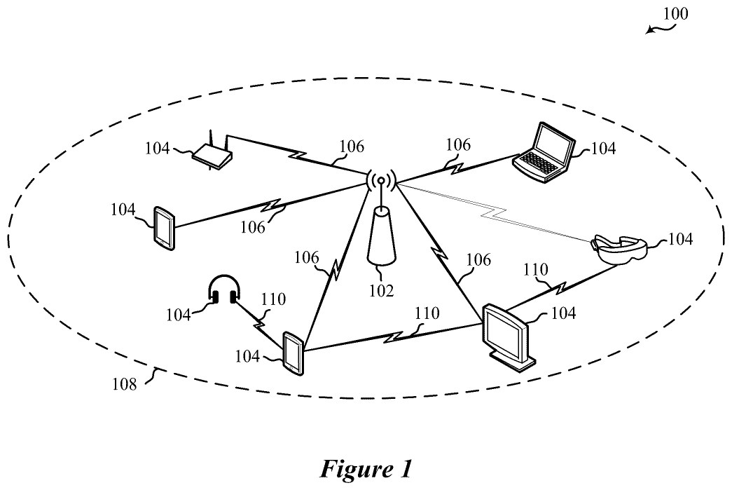

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STA s 104 may support additional ULL applications such as cloud-based applications (such as VR cloud gaming) that have ULL and high throughput requirements.

As indicated above, in some implementations, the AP 102 and the STA s 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY layer protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a transmit opportunity (TXOP) on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (M A C-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TX OP is the duration of time the wireless communication device can transmit frames over the channel after it has “won” contention for the wireless medium. The TX OP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (which may be denoted as “CW”). There are different CW and TX OP durations (e.g., sizes) for each of the four access categories (A Cs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TX OP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some processes, methods, operations, techniques or other aspects described herein may be implemented, at least in part, using an artificial intelligence (AI) program, such as a program that includes a machine learning (M L) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/A P, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid A I/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some example implementations, one or more wireless communication devices (such as one or more APs 102 or one or more STAs 104, or any combination thereof), may support one or more signaling-based or configuration-based mechanisms according to which the one or more wireless communication devices may select a contention window size for a transmission attempt to maintain relatively smaller contention window sizes in some scenarios (such as in accordance with a satisfaction of a first set of one or more conditions) and to use relatively larger contention window sizes in some other scenarios (such as in accordance with a satisfaction of a second set of one or more conditions). Some example scenarios/conditions may include or relate to a congestion level, a quantity of previous transmission attempts, a collision probability, signaled/indicated information, or any combination thereof. In some implementations, for example, a wireless communication device may statically (such as always or for a time duration) use a same contention window size for a given access category (such as for the voice access category). In such implementations, the wireless communication device may use the same contention window size for the access category in accordance with a presence of relatively few traffic flows associated with that access category (such as in accordance with relatively lower network congestion or a relatively low collision probability).

Additionally, or alternatively, a wireless communication device may use, employ, or leverage a contention window size selection scheme that (dynamically or in accordance with signaled information) scales with higher quantities of traffic flows associated with a given access category. In some implementations, for example, the wireless communication device may use a first contention window size for a first quantity of (consecutive) transmission attempts and may use a second contention window size for a second (subsequent) quantity of (consecutive) transmission attempts. In some implementations, the first contention window size may be smaller than the second contention window size. Further, in some implementations, the wireless communication device may receive an indication of one or both of the first quantity or the second quantity. In some other aspects, the wireless communication device may select one or more both of the first quantity or the second quantity. For example, the wireless communication device may select one or both of the first quantity or the second quantity in accordance with a collision probability. Additionally, or alternatively, the wireless communication device may use, employ, or leverage a contention window size selection scheme according to which the wireless communication device may directly map a collision probability to a fixed contention window size. For example, the wireless communication device may use a first contention window size in accordance with determining (such as measuring, calculating, estimating, or receiving information indicative of) a first collision probability and may use a second contention window size in accordance with determining a second collision probability.

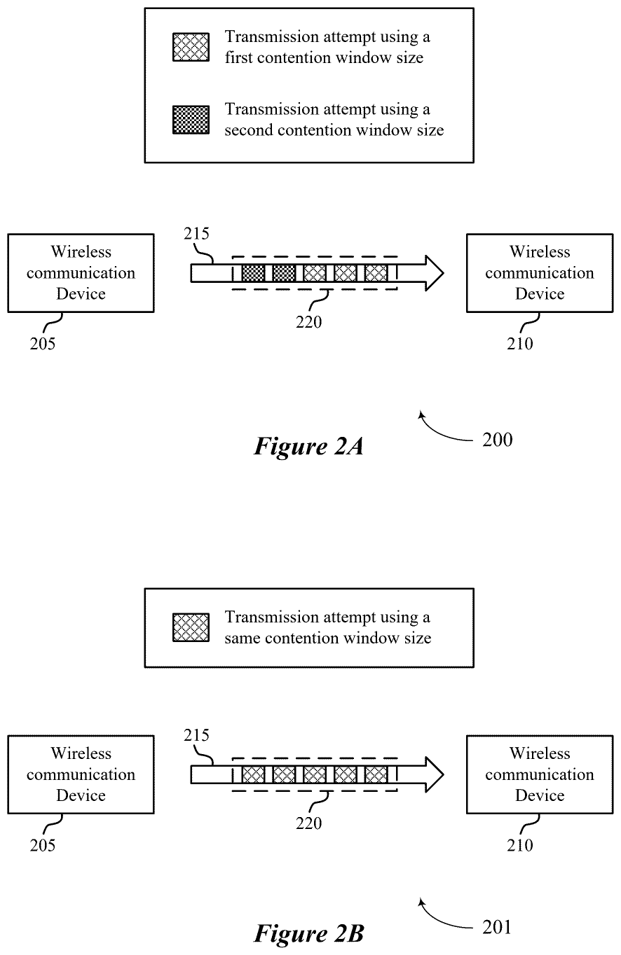

FIGS. 2A and 2B show an example signaling diagram 200 and an example signaling diagram 201, respectively, that support techniques associated with contention window size selection in Wi-Fi systems. The signaling diagram 200 and the signaling diagram 201 may implement or be implemented to realize one or more aspects of the wireless communication network 100. For example, the signaling diagram 200 and the signaling diagram 201 illustrate communication between a wireless communication device 205 and a wireless communication device 210, which may be examples of corresponding devices illustrated and described herein, including by and with reference to FIG. 1.

For example, the wireless communication device 205 may be an AP 102 or a STA 104. By way of further example, the wireless communication device 210 may be an AP 102 or a STA 104. The wireless communication device 205 and the wireless communication device 210 may communicate via a communication link 215. In some implementations, the wireless communication device 205 may perform one or more transmission attempts 220 of a packet associated with a traffic flow, the traffic flow corresponding to or be associated with an access category. The traffic flow may be further associated with an application at one or both of the wireless communication device 205 or the wireless communication device 210.

In some implementations, the wireless communication device 205 and the wireless communication device 210 (such as Wi-Fi nodes) may support different channel access parameters for different access categories. In some implementations, a STA 104 may support different channel access parameters as compared to an AP 102. As described herein, “AC_VO” may refer to a voice access category, “AC_VI” may refer to a video access category, “AC_BE” may refer to a best effort access category, and “AC_BK” may refer to background access category. Generally, the voice access category may be associated with a highest priority, followed by the video access category, followed by the best effort access category, and lastly the background access category. In some implementations, the channel access parameters indicated by Table 1 and Table 2 below may be referred to as or otherwise associated with baseline sets of channel access parameters, including baseline sets of contention window sizes. For example, a baseline set of contention window sizes associated with the voice access category may include a set of contention window sizes in a range of 3-7 (although, in some networks, only 3 and 7 may be used in accordance with the approximate doubling of contention window size in accordance with a failed transmission attempt).

TABLE 1
AP Parameters

| | AP parameters | | |
|---|---|---|---|
| | AIFSN | CW min | CW max |
| AC_VO | 1 | 3 | 7 |
| AC_VI | 1 | 7 | 15 |
| AC_BE | 3 | 15 | 1023 |
| AC_BK | 7 | 15 | 1023 |

TABLE 2
STA Parameters

| | STA parameters | | |
|---|---|---|---|
| | AIFSN | CW min | CW max |
| AC_VO | 2 | 3 | 7 |
| AC_VI | 1 | 7 | 15 |
| AC_BE | 3 | 15 | 1023 |
| AC_BK | 7 | 15 | 1023 |

In the example of the voice access category, a lower limit contention window (referred to as “CW min” in the examples of Tables 1 and 2) size of 3 and an upper limit contention window (referred to as “CWmax” in the examples of Tables 1 and 2) size of 7 may imply that the contention window size progresses as a function of the retry count as [3 7 7 7 7 7 7 7 etc.], which also may be noted herein as [3₁ 7ᵣ], where r stands for ‘repeated’ (such as repeated until reception of an acknowledgment (ACK) or until a packet is dropped/discarded).

In some example implementations, the wireless communication device 205 may support one or more signaling-based or configuration-based mechanisms according to which the wireless communication device 205 may select a contention window size for a transmission attempt 220 to maintain relatively smaller contention window sizes in some scenarios (such as in accordance with a satisfaction of a first set of one or more conditions) and to use relatively larger contention window sizes in some other scenarios (such as in accordance with a satisfaction of a second set of one or more conditions). Such signaling-based or configuration-based mechanism(s) may be defined or used per access category, per device, per network, per communication direction, or per communication link, among other examples.

In some implementations, and as illustrated in the signaling diagram 200, the wireless communication device may perform a first set of transmission attempts 220 of a packet using a first contention window size and may perform a second set of transmission attempts 220 of the packet using a second contention window size. In some examples, the first set of transmission attempts 220 may include two or more transmission attempts. In some examples, the first contention window size may be smaller than the second contention window size. The access category with which the packet is associated (such as the voice access category) may be associated with a baseline set of contention window sizes (such as contention window sizes in the range of 3-7) and, in some examples, the first contention window size may be smaller than a smallest contention window size of the baseline set of contention window sizes (such as 1 or 2). In some other examples, the first contention window size may be a smallest baseline contention window size (such as 3 for the voice access category).

In some examples, a quantity of the first set of transmission attempts 220 may be denoted as x. For example, to scale to higher numbers of traffic flows (such as higher numbers of voice flows), the wireless communication device 205 may use the first contention window size (such as, for example, 1, 2, or 3) for an initial x transmission attempts 220 (for an initial x tries) and may use the second contention window size (such as, for example, 7) for the second set of transmission attempts 220. In other words, the wireless communication device 205 may use the second contention window size for any transmission attempts 220 after the initial x transmission attempts 220. In some implementations, such a sequence of transmission attempts may be denoted as [3ₓ 7ᵣ], where r means ‘repeated.’ For example, x=3 can be written as [3₃ 7ᵣ], which may correspond to a contention window (size) sequence of [3 3 3 7 7 7 7 . . . ] in the retry domain. Additionally, or alternatively, the wireless communication device 205 may support a repeating pattern of contention window sizes. For example, the wireless communication device 205 may support or use a bounded sequence that is repeated. For example, [3₂ 7₁], may correspond to a contention window (size) sequence of [3 3 7 3 3 7 3 3 7 etc.], or, in another notation, [3 3 7]ᵣ.

Example sequences of transmission attempts 220 may include, in examples in which the first contention window size is equal to 3 and the second contention window size is equal to 7, [3ᵣ], [3 7ᵣ], [3₂ 7₅]ᵣ, [3₃ 7₅]ᵣ, [3₄ 7₅]ᵣ, [3₅ 7₅]ᵣ, [3₆ 7₅]ᵣ, [3₃ 7ᵣ], [3₄ 7ᵣ], and [3₅ 7ᵣ], among other examples. Generally, the wireless communication device 205 may support any sequence of transmission attempts 220 of [Nₓ M_{y} . . . P_{z}], with or without repetition. x, y, and z may be the same or may be different. N, M, . . . . P may be different contention window sizes that the wireless communication device 205 may use for the access category associated with the packet attempting to be transmitted. In other words, the wireless communication device may cycle across, switch between, or try two different contention window sizes, three different contention window sizes, four different contention window sizes, or any other quantity of contention window sizes. Generally, the mechanism employed by the wireless communication device 205 may be such that the contention window size for each consecutive transmission attempt 220 does not strictly double (such that some consecutive transmission attempts 220 use a same contention window size, or different contention window sizes that are incremented in a manner that could include incrementing by 1 or any other number, doubling, approximately doubling, or the like).

In some implementations, a value of x may be signaled, such as received from the wireless communication device 210. In some examples, x may be signaled by an AP 102. Additionally, or alternatively, x may be determined dynamically based on a moving average collision probability (Pc) (which may be maintained locally at the wireless communication device 205, such as a STA). In some implementations, x may be relatively lower for a relatively higher Pc. For example, the wireless communication device 205 may support a mapping between different collision probabilities and different quantities of consecutive transmission attempts 220 made using the first contention window size. The wireless communication device 205 may retrieve such a mapping from one or more memories or may receive information indicative of the mapping (such as from an AP 102, such as from the wireless communication device 210).

Additionally, or alternatively, the wireless communication device 205 may support a mechanism according to which the wireless communication device 205 may directly map a moving average collision probability Pc to a fixed contention window size. For example, the wireless communication device 205 may support a mapping between different collision probabilities and different contention window sizes. The wireless communication device 205 may retrieve such a mapping from one or more memories or may receive information indicative of the mapping (such as from an AP 102, such as from the wireless communication device 210). In some examples, the mapping may span a set of available or possible contention window sizes, such that there may be a lower limit contention window size defined by the mapping and an upper limit contention window size defined by the mapping. The lower limit contention window size may be smaller than or equal to a smallest contention widow size associated with a baseline set of contention window sizes associated with the access category.

Accordingly, in some implementations, the wireless communication device 205 may perform the first set of transmission attempts 220 using the first contention window size in association with determining a first collision probability that corresponds to (in accordance with the mapping) the first contention window size. By way of further example, at a different (later) time, the wireless communication device 205 may perform the second set of transmission attempts 220 using the second contention window size in association with determining a second collision probability that corresponds to (in accordance with the mapping) the second contention window size.

Additionally, or alternatively, and as illustrated in the signaling diagram 201, the wireless communication device may statically (for at least a time period) use a same contention window size. For example, the wireless communication device may perform a set of transmission attempts 220 of a packet using a same contention window size. For example, such a single/same contention window size may be equal to 1, 2, or 3. In some implementations, the wireless communication device 205 may determine to use the single/same contention window size in accordance with determining that there is (or is likely to be) a relatively low quantity of traffic flows (such as a relatively low quantity of traffic flows associated with the same access category, such as a relatively low quantity of voice traffic flows). In such implementations, a likelihood of collision may be relatively low such that lower capability devices may not be adversely impacted (and such that backwards compatibility may be achieved).

The described examples may be implemented for uplink communication or downlink communication, or both. In some examples, the wireless communication device 205 and the wireless communication device 210 may exchange capability signaling relating to one or more settings or schemes associated with the transmission attempts 220 and corresponding contention window sizes. For example, one or both of the wireless communication device 205 and the wireless communication device 210 may indicate a capability for using a same contention window size, a capability for using a first contention window size for a first set of transmission attempts 220 and a using a second contention window size (and potentially also a third, fourth, or greater contention window size) for subsequent transmission attempts 220, and/or a capability for directly mapping a collision probability to a contention window size.

Further, the wireless communication device 205 may implement different settings or schemes at a same time or at different times. For example, the wireless communication device 205 may implement aspects related to the signaling diagram 200 during or within a first time period and may implement aspects related to the signaling diagram 201 during or within a second time period. The first time period and the second time period may be the same, may overlap, or may not overlap. Additionally, or alternatively, the wireless communication device 205 may transmit or receive signaling activating one or more aspects related to the signaling diagram 200 or activating one or more aspects related to the signaling diagram 201, or any combination thereof. Additionally, or alternatively, the wireless communication device 205 may perform an autonomous selection of one or more aspects related to the signaling diagram 200 or activating one or more aspects related to the signaling diagram 201, or any combination thereof. For example, the wireless communication device may autonomously select to always use a same contention window size in some scenarios (such as low traffic scenarios) and may autonomously select to use a direct mapping between collision probability and contention window size in some other scenarios (such as in potentially high traffic scenarios, or in high traffic variability scenarios).

The wireless communication device 205 may buffer the collision probability over time, and may update the collision probability over time. The wireless communication device may buffer one or more mappings, and may update the one or more mappings. One or more wireless communication devices may broadcast information indicative of one or more aspects of the signaling diagram 200 or the signaling diagram 201. For example, an AP 102 may indicate that in-BSS STAs 104 and/or OBSS STAs 104 are to use one or more of the contention window selection schemes disclosed herein. A wireless communication device may indicate information associated with one or more of the contention window selection schemes disclosed herein via various frames, packets, fields, or messages, including via beacon frames, trigger frames, association request/response frames, authentication request/response frames, data frames, TX OP sharing frames, or any combination thereof. Further, although sometimes described herein as a client device, a wireless STA may refer to any transmission or reception point, such as any device or component or entity capable of transmitting or receiving. An AP 102 may be understood as being a STA, for example. Further, the described techniques may be applicable to any access category or type of traffic such as any access category or type of traffic that is not rate limited, such any access category or type of traffic for which, for example, the Wi-Fi network is not a bottleneck, among other examples.

In accordance with one or more of the example implementations disclosed herein, one or more wireless communication devices may achieve, for example, an improved (e.g., a more reliable or a more user experience friendly) channel access mechanism for AC-VO (access category-voice) traffic in scenarios in which there are multiple STA voice (VO) sources in the presence of multiple best effort (BE) traffics, among other examples. Further, in accordance with one or more of the example implementations disclosed herein, an AP 102 may inform a STA 104 as to which contention window to use in scenarios in which the AP 102 is aware of a quantity of STA VO sources in process, so as to keep a “tail” latency to within a target or threshold latency.

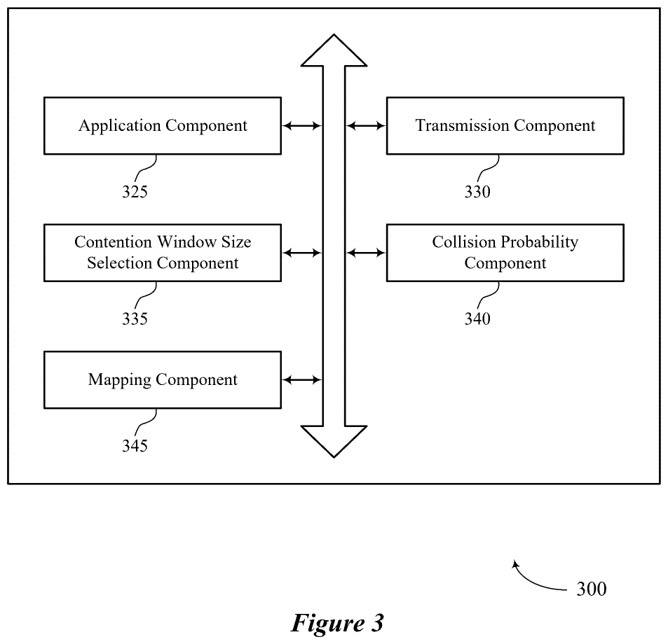

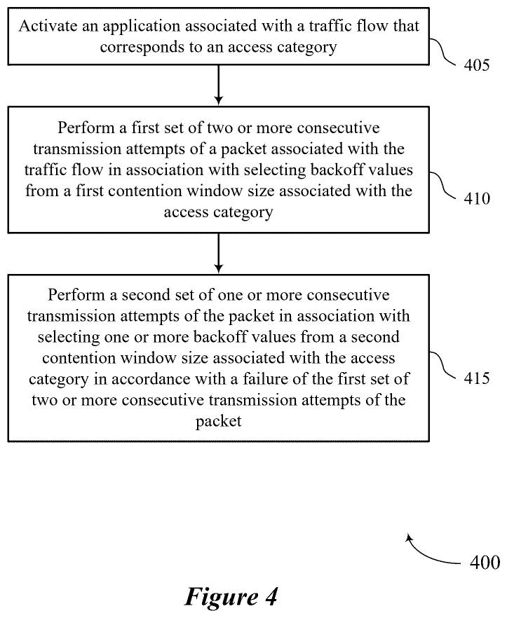

FIG. 3 shows a block diagram of an example wireless communication device 300 that supports techniques associated with contention window size selection in Wi-Fi systems. In some examples, the wireless communication device 300 is configured to perform the processes 400, 500, and 600 described with reference to FIGS. 4, 5, and 6, respectively. The wireless communication device 300 may include one or more chips, SoCs, chipsets, packages, components or devices that individually or collectively constitute or include a processing system. The processing system may interface with other components of the wireless communication device 300, and may generally process information (such as inputs or signals) received from such other components and output information (such as outputs or signals) to such other components. In some implementations, an example chip may include a processing system, a first interface to output or transmit information and a second interface to receive or obtain information. For example, the first interface may refer to an interface between the processing system of the chip and a transmission component, such that the wireless communication device 300 may transmit the information output from the chip. In such an example, the second interface may refer to an interface between the processing system of the chip and a reception component, such that the wireless communication device 300 may receive information that is then passed to the processing system. In some such examples, the first interface also may obtain information, such as from the transmission component, and the second interface also may output information, such as to the reception component.

The processing system of the wireless communication device 300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 300 can be configurable or configured for use in an AP or STA, such as the AP 102 or the STA 104 described with reference to FIG. 1. In some other examples, the wireless communication device 300 can be an AP or STA that includes such a processing system and other components including multiple antennas. The wireless communication device 300 is capable of transmitting and receiving wireless communications in the form of, for example, wireless packets. For example, the wireless communication device 300 can be configurable or configured to transmit and receive packets in the form of physical layer PPDUs and M PDUs conforming to one or more of the IEEE 802.11 family of wireless communication protocol standards. In some other examples, the wireless communication device 300 can be configurable or configured to transmit and receive signals and communications conforming to one or more 3GPP specifications including those for 5G NR or 6G. In some examples, the wireless communication device 300 also includes or can be coupled with one or more application processors which may be further coupled with one or more other memories. In some examples, the wireless communication device 300 further includes a user interface (UI) (such as a touchscreen or keypad) and a display, which may be integrated with the UI to form a touchscreen display that is coupled with the processing system. In some examples, the wireless communication device 300 may further include one or more sensors such as, for example, one or more inertial sensors, accelerometers, temperature sensors, pressure sensors, or altitude sensors, that are coupled with the processing system. In some examples, the wireless communication device 300 further includes at least one external network interface coupled with the processing system that enables communication with a core network or backhaul network that enables the wireless communication device 300 to gain access to external networks including the Internet.

The wireless communication device 300 includes an application component 325, a transmission component 330, a contention window size selection component 335, a collision probability component 340, and a mapping component 345. Portions of one or more of the application component 325, the transmission component 330, the contention window size selection component 335, the collision probability component 340, and the mapping component 345 may be implemented at least in part in hardware or firmware. For example, one or more of the application component 325, the transmission component 330, the contention window size selection component 335, the collision probability component 340, and the mapping component 345 may be implemented at least in part by at least a processor or a modem. In some examples, portions of one or more of the application component 325, the transmission component 330, the contention window size selection component 335, the collision probability component 340, and the mapping component 345 may be implemented at least in part by a processor and software in the form of processor-executable code stored in memory.

The wireless communication device 300 may support wireless communication in accordance with examples as disclosed herein. The application component 325 is configurable or configured to activate an application associated with a traffic flow that corresponds to an access category. The transmission component 330 is configurable or configured to perform a first set of two or more consecutive transmission attempts of a packet associated with the traffic flow in association with selecting backoff values from a first contention window size associated with the access category. In some examples, the transmission component 330 is configurable or configured to perform a second set of one or more consecutive transmission attempts of the packet in association with selecting one or more backoff values from a second contention window size associated with the access category in accordance with a failure of the first set of two or more consecutive transmission attempts of the packet.

In some examples, the contention window size selection component 335 is configurable or configured to receive an indication of a first quantity of the first set of two or more consecutive transmission attempts, where the first quantity is associated with the access category.

In some examples, the collision probability component 340 is configurable or configured to determine, within a first time period, a first collision probability associated with transmission attempts from the wireless STA. In some examples, the contention window size selection component 335 is configurable or configured to determine a first quantity of the first set of two or more consecutive transmission attempts in accordance with the first collision probability, where performing the first set of two or more consecutive transmission attempts is in association with determining the first quantity of the first set of two or more consecutive transmission attempts.

In some examples, the collision probability component 340 is configurable or configured to determine, within a second time period, a second collision probability associated with the transmission attempts from the wireless STA. In some examples, the contention window size selection component 335 is configurable or configured to update the first quantity to a second quantity in accordance with the second collision probability.

In some examples, a mapping associated with the access category indicates a correspondence between a set of collision probabilities and a set of quantities of consecutive transmission attempts using the first contention window size.

In some examples, in accordance with the mapping, a relatively smallest quantity of consecutive transmission attempts using the first contention window size corresponds to a relatively highest collision probability of the set of collision probabilities and a relatively largest quantity of consecutive transmission attempts using the first contention window size corresponds to a relatively lowest collision probability of the set of collision probabilities.

In some examples, the mapping component 345 is configurable or configured to receive an indication of the mapping.

In some examples, the second set of one or more consecutive transmission attempts includes repeated transmission attempts using the second contention window size until a reception of an acknowledgment associated with the packet or until the packet is dropped or discarded.

In some examples, the first set of two or more consecutive transmission attempts includes a first quantity of consecutive transmission attempts and the second set of one or more consecutive transmission attempts includes a second quantity of consecutive transmission attempts. In some examples, the access category is associated with a repeating pattern of the first quantity of consecutive transmission attempts using the first contention window size followed by the second quantity of consecutive transmission attempts using the second contention window size.

In some examples, the first set of two or more consecutive transmission attempts and the second set of one or more consecutive transmission attempts are associated with a sequence of consecutive transmission attempts of the packet according to which a contention window size is not doubled in accordance with an initial transmission attempt of the packet failing.

In some examples, the first contention window size is smaller than the second contention window size.

In some examples, the access category is associated a baseline set of contention window sizes. In some examples, the first contention window size is smaller than a smallest contention window size of the baseline set of contention window sizes.

Additionally, or alternatively, the wireless communication device 300 may support wireless communication in accordance with examples as disclosed herein. In some examples, the application component 325 is configurable or configured to activate an application associated with a traffic flow that corresponds to an access category. In some examples, the transmission component 330 is configurable or configured to perform a transmission attempt of a packet associated with the traffic flow in association with selecting a backoff value from a first contention window size, where the first contention window size is associated with both the access category and a first collision probability associated with transmission attempts from the wireless STA.

In some examples, the collision probability component 340 is configurable or configured to determine, within a first time period, the first collision probability associated with the transmission attempts from the wireless STA. In some examples, the contention window size selection component 335 is configurable or configured to determine the first contention window size in accordance with the first collision probability, where performing the transmission attempt in association with selecting the backoff value from the first contention window size is based on determining the first contention window size in accordance with the first collision probability.

In some examples, the collision probability component 340 is configurable or configured to determine, within a second time period, a second collision probability associated with the transmission attempts from the wireless STA. In some examples, the contention window size selection component 335 is configurable or configured to determine a second contention window size in accordance with the second collision probability. In some examples, the transmission component 330 is configurable or configured to perform a second transmission attempt of the packet or a second packet associated with the traffic flow in association with selecting a second backoff value from the second contention window size in accordance with determining the second contention window size in accordance with the second collision probability.

In some examples, a mapping associated with the access category indicates a correspondence between a set of collision probabilities and a set of contention window sizes.

In some examples, the set of contention window sizes is associated with a lower limit contention window size and an upper limit contention window size.

In some examples, in accordance with the mapping, a relatively largest contention window size of the set of contention window sizes corresponds to a relatively highest collision probability of the set of collision probabilities and a relatively smallest contention window size of the set of contention window sizes corresponds to a relatively lowest collision probability of the set of collision probabilities.

In some examples, the mapping component 345 is configurable or configured to receive an indication of the mapping.

Additionally, or alternatively, the wireless communication device 300 may support wireless communication in accordance with examples as disclosed herein. In some examples, the application component 325 is configurable or configured to activate an application associated with a traffic flow that corresponds to an access category. In some examples, the transmission component 330 is configurable or configured to perform a set of two or more consecutive transmission attempts of a packet associated with the traffic flow in association with selecting backoff values from a contention window size associated with the access category in accordance with a collision probability associated with transmission attempts from the wireless STA satisfying a threshold probability.

In some examples, the collision probability satisfying the threshold probability includes the collision probability being less than the threshold probability.

In some examples, the collision probability satisfying the threshold probability indicates a presence of fewer than a threshold quantity of traffic flows associated with the access category in a vicinity of the wireless STA.

In some examples, the contention window size is equal to three.

In some examples, the contention window size is equal to two. In some examples, the contention window size is equal to one.

In some examples, the set of two or more consecutive transmission attempts includes repeated transmission attempts using the contention window size until a reception of an acknowledgment associated with the packet or until the packet is dropped or discarded.

FIG. 4 shows a flowchart illustrating an example process 400 performable by or at a wireless STA that supports techniques associated with contention window size selection in Wi-Fi systems. The operations of the process 400 may be implemented by a wireless STA or its components as described herein. For example, the process 400 may be performed by a wireless communication device, such as the wireless communication device 300 described with reference to FIG. 3, operating as or within a wireless AP or a wireless STA. In some examples, the process 400 may be performed by a wireless AP or a wireless STA, such as one of the APs 102 or the STA s 104 described with reference to FIG. 1.

In some examples, in 405, the wireless STA may activate an application associated with a traffic flow that corresponds to an access category. The operations of 405 may be performed in accordance with examples as disclosed herein, such as in accordance with the wireless communication device 205 or the wireless communication device 210 of FIGS. 2A and 2B activating an application associated with a traffic flow. In some implementations, aspects of the operations of 405 may be performed by an application component 325 as described with reference to FIG. 3. Additionally, or alternatively, a processing system of the wireless communication device 300, as described with reference to FIG. 3, may be configured to cause the wireless communication device 300 to perform aspects of the operations of 405.

In some examples, in 410, the wireless STA may perform a first set of two or more consecutive transmission attempts of a packet associated with the traffic flow in association with selecting backoff values from a first contention window size associated with the access category. The operations of 410 may be performed in accordance with examples as disclosed herein, such as in accordance with a first set of transmission attempts 220 by the wireless communication device 205 of FIG. 2A. In some implementations, aspects of the operations of 410 may be performed by a transmission component 330 as described with reference to FIG. 3. Additionally, or alternatively, a processing system of the wireless communication device 300, as described with reference to FIG. 3, may be configured to cause the wireless communication device 300 to perform aspects of the operations of 410.

In some examples, in 415, the wireless STA may perform a second set of one or more consecutive transmission attempts of the packet in association with selecting one or more backoff values from a second contention window size associated with the access category in accordance with a failure of the first set of two or more consecutive transmission attempts of the packet. The operations of 415 may be performed in accordance with examples as disclosed herein, such as in accordance with a second set of transmission attempts 220 by the wireless communication device 205 of FIG. 2A. In some implementations, aspects of the operations of 415 may be performed by a transmission component 330 as described with reference to FIG. 3. Additionally, or alternatively, a processing system of the wireless communication device 300, as described with reference to FIG. 3, may be configured to cause the wireless communication device 300 to perform aspects of the operations of 415.

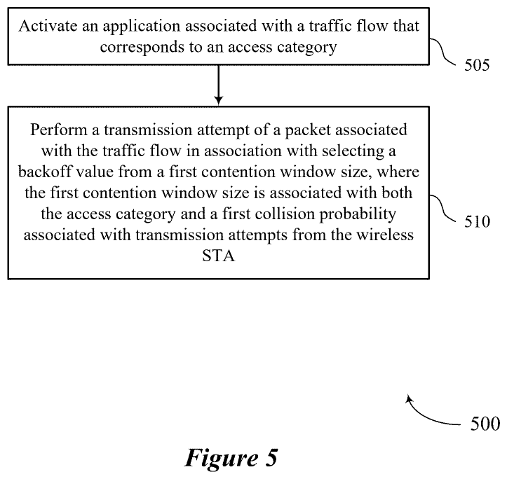

FIG. 5 shows a flowchart illustrating an example process 500 performable by or at a wireless STA that supports techniques associated with contention window size selection in Wi-Fi systems. The operations of the process 500 may be implemented by a wireless STA or its components as described herein. For example, the process 500 may be performed by a wireless communication device, such as the wireless communication device 300 described with reference to FIG. 3, operating as or within a wireless AP or a wireless STA. In some examples, the process 500 may be performed by a wireless AP or a wireless STA, such as one of the APs 102 or the STAs 104 described with reference to FIG. 1.

In some examples, in 505, the wireless STA may activate an application associated with a traffic flow that corresponds to an access category. The operations of 505 may be performed in accordance with examples as disclosed herein, such as in accordance with the wireless communication device 205 or the wireless communication device 210 of FIGS. 2A and 2B activating an application associated with a traffic flow. In some implementations, aspects of the operations of 505 may be performed by an application component 325 as described with reference to FIG. 3. Additionally, or alternatively, a processing system of the wireless communication device 300, as described with reference to FIG. 3, may be configured to cause the wireless communication device 300 to perform aspects of the operations of 505.

In some examples, in 510, the wireless STA may perform a transmission attempt of a packet associated with the traffic flow in association with selecting a backoff value from a first contention window size, where the first contention window size is associated with both the access category and a first collision probability associated with transmission attempts from the wireless STA. The operations of 510 may be performed in accordance with examples as disclosed herein, such as in accordance with one or more transmission attempts 220 by the wireless communication device 205 of FIGS. 2A and 2B. In some implementations, aspects of the operations of 510 may be performed by a transmission component 330 as described with reference to FIG. 3. Additionally, or alternatively, a processing system of the wireless communication device 300, as described with reference to FIG. 3, may be configured to cause the wireless communication device 300 to perform aspects of the operations of 510.

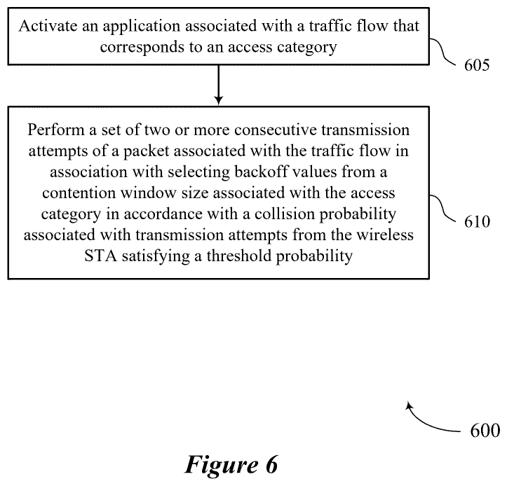

FIG. 6 shows a flowchart illustrating an example process 600 performable by or at a wireless STA that supports techniques associated with contention window size selection in Wi-Fi systems. The operations of the process 600 may be implemented by a wireless STA or its components as described herein. For example, the process 600 may be performed by a wireless communication device, such as the wireless communication device 300 described with reference to FIG. 3, operating as or within a wireless AP or a wireless STA. In some examples, the process 600 may be performed by a wireless AP or a wireless STA, such as one of the APs 102 or the STAs 104 described with reference to FIG. 1.

In some examples, in 605, the wireless STA may activate an application associated with a traffic flow that corresponds to an access category. The operations of 605 may be performed in accordance with examples as disclosed herein, such as in accordance with the wireless communication device 205 or the wireless communication device 210 of FIGS. 2A and 2B activating an application associated with a traffic flow. In some implementations, aspects of the operations of 605 may be performed by an application component 325 as described with reference to FIG. 3. Additionally, or alternatively, a processing system of the wireless communication device 300, as described with reference to FIG. 3, may be configured to cause the wireless communication device 300 to perform aspects of the operations of 605.

In some examples, in 610, the wireless STA may perform a set of two or more consecutive transmission attempts of a packet associated with the traffic flow in association with selecting backoff values from a contention window size associated with the access category in accordance with a collision probability associated with transmission attempts from the wireless STA satisfying a threshold probability. The operations of 610 may be performed in accordance with examples as disclosed herein, such as in accordance with one or more transmission attempts 220 by the wireless communication device 205 of FIGS. 2A and 2B. In some implementations, aspects of the operations of 610 may be performed by a transmission component 330 as described with reference to FIG. 3. Additionally, or alternatively, a processing system of the wireless communication device 300, as described with reference to FIG. 3, may be configured to cause the wireless communication device 300 to perform aspects of the operations of 610.

Implementation examples are described in the following numbered clauses:

Clause 1: A method for wireless communication at a wireless STA (or any other wireless communication device), including: activating an application associated with a traffic flow that corresponds to an access category; performing a first set of two or more consecutive transmission attempts of a packet associated with the traffic flow in association with selecting (such as in association with a first selection of) backoff values from a first contention window size associated with the access category; and performing a second set of one or more consecutive transmission attempts of the packet in association with selecting (such as in association with a second selection of) one or more backoff values from a second contention window size associated with the access category in accordance with a failure of the first set of two or more consecutive transmission attempts of the packet.

Clause 2: The method of clause 1, further including: receiving an indication of a first quantity of the first set of two or more consecutive transmission attempts, where the first quantity is associated with the access category.

Clause 3: The method of any of clauses 1-2, further including: determining, within a first time period, a first collision probability associated with transmission attempts from the wireless STA; and determining a first quantity of the first set of two or more consecutive transmission attempts in accordance with the first collision probability, where performing the first set of two or more consecutive transmission attempts is in association with determining the first quantity of the first set of two or more consecutive transmission attempts.

Clause 4: The method of clause 3, further including: determining, within a second time period, a second collision probability associated with the transmission attempts from the wireless STA; and updating the first quantity to a second quantity in accordance with the second collision probability.

Clause 5: The method of any of clauses 3-4, where a mapping associated with the access category indicates a correspondence between a set of collision probabilities and a set of quantities of consecutive transmission attempts using the first contention window size.

Clause 6: The method of clause 5, where in accordance with the mapping, a relatively smallest quantity of consecutive transmission attempts using the first contention window size corresponds to a relatively highest collision probability of the set of collision probabilities and a relatively largest quantity of consecutive transmission attempts using the first contention window size corresponds to a relatively lowest collision probability of the set of collision probabilities.

Clause 7: The method of any of clauses 5-6, further including: receiving an indication of the mapping.

Clause 8: The method of any of clauses 1-7, where the second set of one or more consecutive transmission attempts includes repeated transmission attempts using the second contention window size until a reception of an acknowledgment associated with the packet or until the packet is dropped or discarded.

Clause 9: The method of any of clauses 1-8, where the first set of two or more consecutive transmission attempts includes a first quantity of consecutive transmission attempts and the second set of one or more consecutive transmission attempts includes a second quantity of consecutive transmission attempts; and the access category is associated with a repeating pattern of the first quantity of consecutive transmission attempts using the first contention window size followed by the second quantity of consecutive transmission attempts using the second contention window size.

Clause 10: The method of any of clauses 1-9, where the first set of two or more consecutive transmission attempts and the second set of one or more consecutive transmission attempts are associated with a sequence of consecutive transmission attempts of the packet according to which a contention window size is not doubled in accordance with an initial transmission attempt of the packet failing.

Clause 11: The method of any of clauses 1-10, where the first contention window size is smaller than the second contention window size.

Clause 12: The method of any of clauses 1-11, where the access category is associated a baseline set of contention window sizes, and the first contention window size is smaller than a smallest contention window size of the baseline set of contention window sizes.

Clause 13: A method for wireless communication at a wireless STA (or any other wireless communication device), including: activating an application associated with a traffic flow that corresponds to an access category; and performing a transmission attempt of a packet associated with the traffic flow in association with selecting a backoff value from a first contention window size, where the first contention window size is associated with both the access category and a first collision probability associated with transmission attempts from the wireless STA.

Clause 14: The method of clause 13, further including: determining, within a first time period, the first collision probability associated with the transmission attempts from the wireless STA; and determining the first contention window size in accordance with the first collision probability, where performing the transmission attempt in association with selecting the backoff value from the first contention window size is based at least in part on determining the first contention window size in accordance with the first collision probability.

Clause 15: The method of clause 14, further including: determining, within a second time period, a second collision probability associated with the transmission attempts from the wireless STA; determining a second contention window size in accordance with the second collision probability; and performing a second transmission attempt of the packet or a second packet associated with the traffic flow in association with selecting a second backoff value from the second contention window size in accordance with determining the second contention window size in accordance with the second collision probability.

Clause 16: The method of any of clauses 13-15, where a mapping associated with the access category indicates a correspondence between a set of collision probabilities and a set of contention window sizes.

Clause 17: The method of clause 16, where the set of contention window sizes is associated with a lower limit contention window size and an upper limit contention window size.

Clause 18: The method of any of clauses 16-17, where in accordance with the mapping, a relatively largest contention window size of the set of contention window sizes corresponds to a relatively highest collision probability of the set of collision probabilities and a relatively smallest contention window size of the set of contention window sizes corresponds to a relatively lowest collision probability of the set of collision probabilities.

Clause 19: The method of any of clauses 16-18, further including: receiving an indication of the mapping.

Clause 20: A method for wireless communication at a wireless STA (or any other wireless communication device), including: activating an application associated with a traffic flow that corresponds to an access category; and performing a set of two or more consecutive transmission attempts of a packet associated with the traffic flow in association with selecting backoff values from a contention window size associated with the access category in accordance with a collision probability associated with transmission attempts from the wireless STA satisfying a threshold probability.

Clause 21: The method of clause 20, where the collision probability satisfying the threshold probability includes the collision probability being less than the threshold probability.

Clause 22: The method of any of clauses 20-21, where the collision probability satisfying the threshold probability indicates a presence of fewer than a threshold quantity of traffic flows associated with the access category in a vicinity of the wireless STA.

Clause 23: The method of any of clauses 20-22, where the contention window size is equal to three.

Clause 24: The method of any of clauses 20-22, where the contention window size is equal to two.

Clause 25: The method of any of clauses 20-22, where the contention window size is equal to one.

Clause 26: The method of any of clauses 20-25, where the set of two or more consecutive transmission attempts includes repeated transmission attempts using the contention window size until a reception of an acknowledgment associated with the packet or until the packet is dropped or discarded.

Clause 27: A wireless STA (or any other wireless communication device) for wireless communication, including a processing system that includes processor circuitry and memory circuitry that stores code, the processing system configured to cause the wireless STA to perform a method of any of clauses 1-12.

Clause 28: A wireless STA (or any other wireless communication device) for wireless communication, including one or more memories storing processor-executable code, and one or more processors coupled with the one or more memories and individually or collectively operable to execute the code to cause the wireless STA to perform a method of any of clauses 1-12.

Clause 29: A wireless STA (or any other wireless communication device) for wireless communication, including at least one means for performing a method of any of clauses 1-12.

Clause 30: A non-transitory computer-readable medium storing code for wireless communication, the code including instructions executable by one or more processors to perform a method of any of clauses 1-12.

Clause 31: A wireless STA (or any other wireless communication device) for wireless communication, including a processing system that includes processor circuitry and memory circuitry that stores code, the processing system configured to cause the wireless STA to perform a method of any of clauses 13-19.

Clause 32: A wireless STA (or any other wireless communication device) for wireless communication, including one or more memories storing processor-executable code, and one or more processors coupled with the one or more memories and individually or collectively operable to execute the code to cause the wireless STA to perform a method of any of clauses 13-19.

Clause 33: A wireless STA (or any other wireless communication device) for wireless communication, including at least one means for performing a method of any of clauses 13-19.

Clause 34: A non-transitory computer-readable medium storing code for wireless communication, the code including instructions executable by one or more processors to perform a method of any of clauses 13-19.

Clause 35: A wireless STA (or any other wireless communication device) for wireless communication, including a processing system that includes processor circuitry and memory circuitry that stores code, the processing system configured to cause the wireless STA to perform a method of any of clauses 20-26.

Clause 36: A wireless STA (or any other wireless communication device) for wireless communication, including one or more memories storing processor-executable code, and one or more processors coupled with the one or more memories and individually or collectively operable to execute the code to cause the wireless STA to perform a method of any of clauses 20-26.

Clause 37: A wireless STA (or any other wireless communication device) for wireless communication, including at least one means for performing a method of any of clauses 20-26.

Clause 38: A non-transitory computer-readable medium storing code for wireless communication, the code including instructions executable by one or more processors to perform a method of any of clauses 20-26.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless station (STA), comprising:
a processing system that includes processor circuitry and memory circuitry that stores code, the processing system configured to cause the wireless STA to:
activate an application associated with a traffic flow that corresponds to an access category;
perform a first set of two or more consecutive transmission attempts of a packet associated with the traffic flow in association with a first selection of backoff values from a first contention window size associated with the access category; and
perform a second set of one or more consecutive transmission attempts of the packet in association with a second selection of one or more backoff values from a second contention window size associated with the access category in accordance with a failure of the first set of two or more consecutive transmission attempts of the packet.

2. The wireless STA of claim 1, wherein the processing system is further configured to cause the wireless STA to:
receive an indication of a first quantity of the first set of two or more consecutive transmission attempts, wherein the first quantity is associated with the access category.

3. The wireless STA of claim 1, wherein:
a first time period has a first collision probability associated with transmission attempts from the wireless STA; and
a first quantity of the first set of two or more consecutive transmission attempts is in accordance with the first collision probability.

4. The wireless STA of claim 3, wherein a second time period has a second collision probability associated with the transmission attempts from the wireless STA, and wherein the processing system is further configured to cause the wireless STA to:
update the first quantity to a second quantity in accordance with the second collision probability.

5. The wireless STA of claim 3, wherein a mapping associated with the access category indicates a correspondence between a set of collision probabilities and a set of quantities of consecutive transmission attempts using the first contention window size.

6. The wireless STA of claim 5, wherein, in accordance with the mapping, a relatively smallest quantity of consecutive transmission attempts using the first contention window size corresponds to a relatively highest collision probability of the set of collision probabilities and a relatively largest quantity of consecutive transmission attempts using the first contention window size corresponds to a relatively lowest collision probability of the set of collision probabilities.

7. The wireless STA of claim 5, wherein the processing system is further configured to cause the wireless STA to:
receive an indication of the mapping.

8. The wireless STA of claim 1, wherein the second set of one or more consecutive transmission attempts includes repeated transmission attempts using the second contention window size until a reception of an acknowledgment associated with the packet or until the packet is dropped or discarded.

9. The wireless STA of claim 1, wherein:
the first set of two or more consecutive transmission attempts includes a first quantity of consecutive transmission attempts and the second set of one or more consecutive transmission attempts includes a second quantity of consecutive transmission attempts; and
the access category is associated with a repeating pattern of the first quantity of consecutive transmission attempts using the first contention window size followed by the second quantity of consecutive transmission attempts using the second contention window size.

10. The wireless STA of claim 1, wherein the first set of two or more consecutive transmission attempts and the second set of one or more consecutive transmission attempts are associated with a sequence of consecutive transmission attempts of the packet according to which a contention window size is not doubled in accordance with an initial transmission attempt of the packet failing.

11. The wireless STA of claim 1, wherein:
the access category is associated a baseline set of contention window sizes, and
the first contention window size is smaller than a smallest contention window size of the baseline set of contention window sizes.

12. A wireless station (STA), comprising:
a processing system that includes processor circuitry and memory circuitry that stores code, the processing system configured to cause the wireless STA to:
activate an application associated with a traffic flow that corresponds to an access category; and
perform a transmission attempt of a packet associated with the traffic flow in association with a selection of a backoff value from a first contention window size, wherein the first contention window size is associated with both the access category and a first collision probability associated with transmission attempts from the wireless STA.

13. The wireless STA of claim 12, wherein a first time period has the first collision probability associated with the transmission attempts from the wireless STA.

14. The wireless STA of claim 13, wherein a second time period has a second collision probability associated with the transmission attempts from the wireless STA, wherein a second contention window size is associated with the second collision probability, and wherein the processing system is further configured to cause the wireless STA to:
perform a second transmission attempt of the packet or a second packet associated with the traffic flow in association with a second selection of a second backoff value from the second contention window size.

15. The wireless STA of claim 12, wherein a mapping associated with the access category indicates a correspondence between a set of collision probabilities and a set of contention window sizes.

16. The wireless STA of claim 15, wherein the set of contention window sizes is associated with a lower limit contention window size and an upper limit contention window size.

17. The wireless STA of claim 15, wherein in accordance with the mapping, a relatively largest contention window size of the set of contention window sizes corresponds to a relatively highest collision probability of the set of collision probabilities and a relatively smallest contention window size of the set of contention window sizes corresponds to a relatively lowest collision probability of the set of collision probabilities.

18. A wireless station (STA), comprising:
a processing system that includes processor circuitry and memory circuitry that stores code, the processing system configured to cause the wireless STA to:
activate an application associated with a traffic flow that corresponds to an access category; and
perform a set of two or more consecutive transmission attempts of a packet associated with the traffic flow in association with a selection of backoff values from a contention window size associated with the access category in accordance with a collision probability associated with transmission attempts from the wireless STA satisfying a threshold probability.

19. The wireless STA of claim 18, wherein:
the collision probability satisfying the threshold probability comprises the collision probability being less than the threshold probability; or
the collision probability satisfying the threshold probability indicates a presence of fewer than a threshold quantity of traffic flows associated with the access category in a vicinity of the wireless STA.

20. The wireless STA of claim 18, wherein the set of two or more consecutive transmission attempts includes repeated transmission attempts using the contention window size until a reception of an acknowledgment associated with the packet or until the packet is dropped or discarded.
